(19) United States
(12) Patent Application Publication
(10) Pub. No.: US 2019/0297853 A1
(43) Pub. Date: Oct. 3, 2019

(54) PET WALKING DEVICE AND METHOD

(71) Applicant: Sean Blakemore, Glendale, CA (US)

(72) Inventor: Sean Blakemore, Glendale, CA (US)

(21) Appl. No.: 16/370,716

(22) Filed: Mar. 29, 2019

Related U.S. Application Data
(60) Provisional application No. 62/651,538, filed on Apr. 2, 2018.

(51) Int. Cl. A01K 27/00; B65H 75/40; B65H 75/44

(52) U.S. Cl. CPC A01K 27/004; A01K 27/006; B65H 2701/35; B65H 75/4471; B65H 75/4431; B65H 75/406

(57) ABSTRACT

A pet walking device for walking a plurality of pets comprising a top housing with a handle and a bottom housing; a swivel coupling rotatably coupling the bottom housing to the top housing for 360 degree rotation; a plurality of co-axial overlapping spool assemblies independently rotatably disposed within the bottom housing; and a leash carried by each of the plurality of co-axial overlapping spool assemblies.

### CROSS REFERENCE TO RELATED APPLICATIONS

This application claims priority to U.S. Provisional patent application No. 62/651,538, filed Apr. 2, 2018 under 35 U.S.C. 119, which is incorporated by reference herein.

### FIELD OF THE INVENTION

The present invention relates, in general, to the field of animal restraint devices, and, in particular, to pet walking/leash devices.

### BACKGROUND OF THE INVENTION

Retractable dog leashes have become extremely popular in recent years, and are widely available in different strengths and lengths for various breeds. Basically, a retractable leash consists of a handle, within which is a spring-loaded reel on which the leash is wound. By releasing or locking a thumb-button, the walker can control the length of the leash, allowing the dog to range farther, or keeping the dog at a specific distance. The retractable leashes are designed with a single leash, and not intended for walking more than one dog. In order to walk two dogs, the walker must fall back upon traditional leashes and, unless one keeps both dogs on a very short leash, the dogs and their leashes will get tangled.

### SUMMARY OF THE INVENTION

An aspect of the invention involves a pet walking device for walking two or more pets simultaneously. The pet walking device includes an upper component including a handle and a lower component rotatably coupled to the upper component. The lower component includes two or more retractable leashes attachable to two or more pets for walking two or more pets simultaneously without entanglement of the two or more leashes.

One or more implementations of the aspect of the invention described immediately above includes one or more of the following: the two or more retractable leashes are spooled on two or more side-by-side, co-axial over lapping spools; a light assembly mountable to a bottom of the lower component, the light assembly including a light and a push button operable once to turn on the light, operable twice to cause the light to repeatedly flash, and operable three times to turn the light off; and/or the upper component includes a lock and release mechanism to lock and release the retractable leash.

Another aspect of the invention involves a pet walking device for walking a plurality of pets comprising a top housing with a handle and a bottom housing; a swivel coupling rotatably coupling the bottom housing to the top housing for 360 degree rotation; a plurality of co-axial overlapping spool assemblies independently rotatably disposed within the bottom housing; and a leash carried by each of the plurality of co-axial overlapping spool assemblies.

One or more implementations of the aspect of the invention described immediately above includes one or more of the following: the top housing includes a lock and unlock device operably associated with the plurality of co-axial overlapping spool assemblies to lock and unlock rotation of the plurality of co-axial overlapping spool assemblies; the plurality of co-axial overlapping spool assemblies include a plurality of engagement sections that the lock and unlock device engages and disengages to simultaneously lock and unlock rotation of the plurality of co-axial overlapping spool assemblies; the lock and unlock device is movably disposed within the swivel coupling; the lock and unlock device includes a plunger movably disposed within the swivel coupling; the plurality of co-axial overlapping spool assemblies include respective springs; the handle includes a grip; the bottom housing includes a lighting assembly; the lighting assembly includes one or more circuits to put the lighting assembly in a constant on condition, a flash condition, and an off condition.

A further aspect of the invention involves a pet walking device for walking a plurality of pets, the pet walking device including a top housing with a handle and a bottom housing; a swivel coupling rotatably coupling the bottom housing to the top housing for 360 degree rotation; a plurality of co-axial overlapping spool assemblies independently rotatably disposed within the bottom housing; and a leash carried by each of the plurality of co-axial overlapping spool assemblies, the method comprising rotating the bottom housing with respect to the top housing; and independently rotating the plurality of co-axial overlapping spool assemblies relative to each other within the bottom housing for each leash.

One or more implementations of the aspect of the invention described immediately above includes one or more of the following: the plurality of co-axial overlapping spool assemblies include a plurality of engagement sections that the lock and unlock device engages and disengages to simultaneously lock and unlock rotation of the plurality of co-axial overlapping spool assemblies, and the method further comprising engaging and disengaging the plurality of engagement sections of the co-axial overlapping spool assemblies with the lock and unlock device to simultaneously lock and unlock rotation of the plurality of co-axial overlapping spool assemblies; the lock and unlock device is movably disposed within the swivel coupling to engage and disengage the plurality of engagement sections of the co-axial overlapping spool assemblies; the lighting assembly includes one or more circuits to put the lighting assembly in a constant on condition, a flash condition, and an off condition, and the method further comprising causing the one or more circuits to put the lighting assembly in a constant on condition, a flash condition, and an off condition.

### BRIEF DESCRIPTION OF DRAWINGS

The accompanying drawings, which are incorporated in and form a part of this specification illustrate embodiments of the invention and together with the description, serve to explain the principles of the invention.

FIG. 1 is a perspective view of an embodiment of a pet walking device;

FIG. 2 is a top plan view of the pet walking device of FIG. 1;

FIG. 3 is exploded perspective view of the pet walking device of FIG. 1;

FIG. 4 is a perspective view of an embodiment of a light assembly of the pet walking device of FIG. 1;

FIG. 5 is an exploded perspective view of the light assembly of FIG. 4;

FIG. 6 is an enlarged perspective view of one half of the pet walking device of FIG. 1.

### DESCRIPTION OF EMBODIMENT OF THE INVENTION

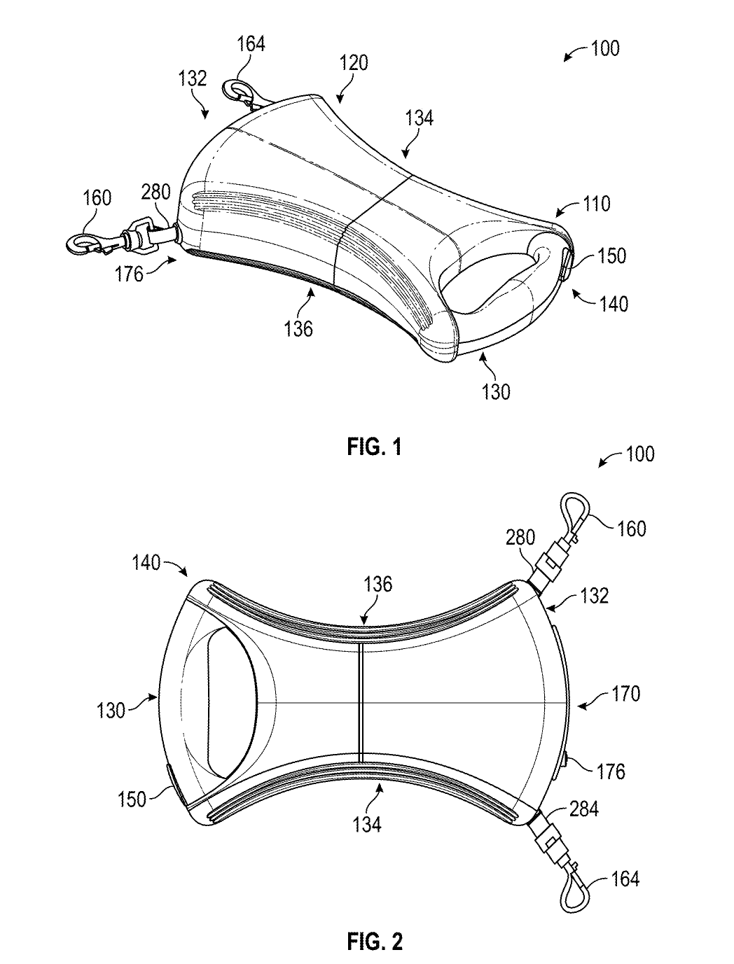

With reference to FIGS. 1-6, a pet walking device 100 for walking two or more pets simultaneously will be described.

The pet walking device 100 is a single unit including a top housing 110 with two substantially symmetrical halves 114, 118 and a bottom housing 120 with two substantially symmetrical halves 124, 128. The pet walking device 100 includes an hourglass shape and formed of a tough and durable, injection-molded thermoplastic. The pet walking device 100 comprises an essentially four sided configuration. An upper side 130 and lower side 132 include convex arcs and two sides 134, 136 include concave arcs. The pet walking device 100 is bifurcated with the top housing 110 and the bottom housing 120 rotatably attached to each other for relative 360 degree with a swivel coupling 138. In an alternative embodiment, the swivel coupling 138 includes ball bearings. The top housing 110 includes a curved handle 140 surmounted with an arcuate, ergonomically contoured first and second handle cover members 144, 148. The handle 140 carries a main lock/unlock button 150 of a main lock/unlock device 154. The main lock/unlock button 150 is manipulated by a user's thumb to allow a pair of independent leashes 160, 164 to be unreeled or locked in place.

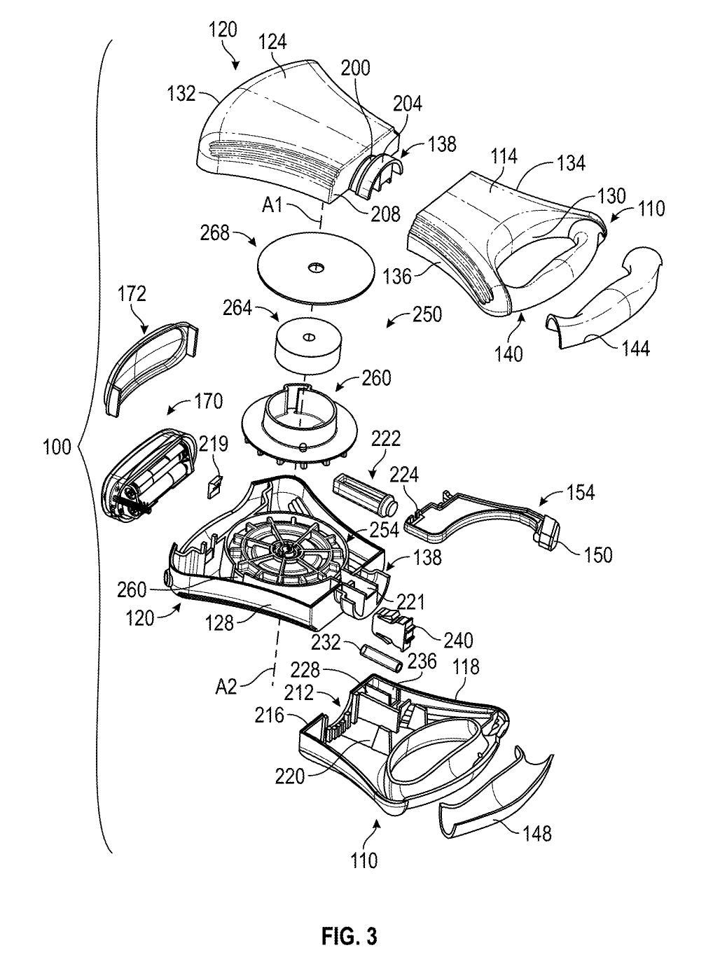

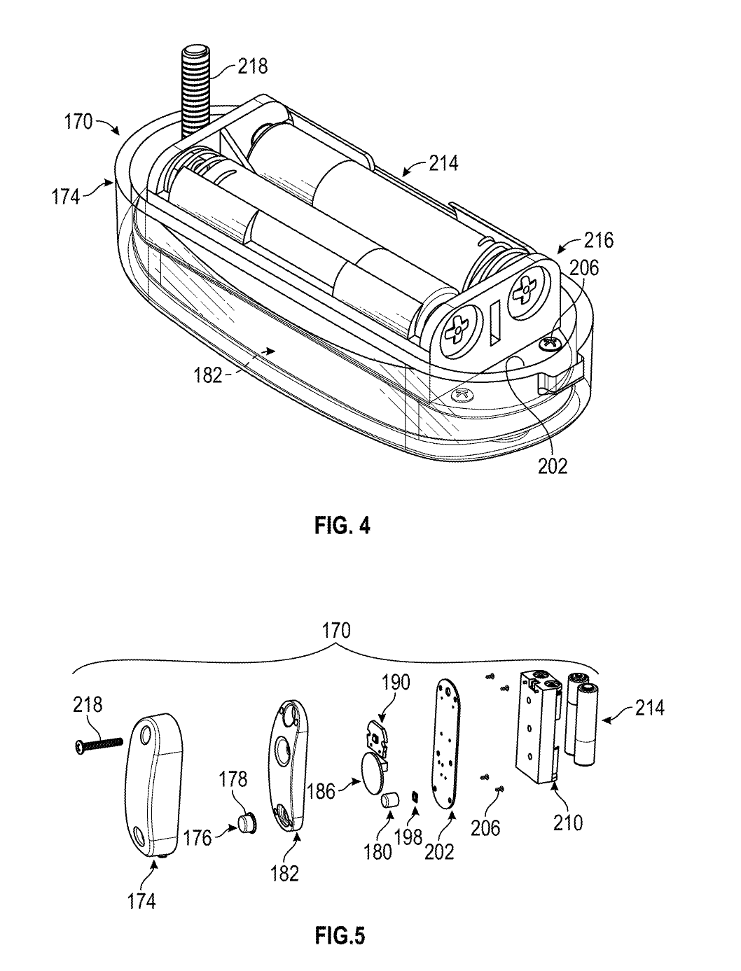

With reference additionally to FIGS. 4 and 5, at an opposite end of the pet walking device 100, a lighting assembly 170 with associated lighting assembly cover 172 is disposed in the convex arc of the lower side 132. The lighting assembly 170 includes a clear lens 174, a button 176 including a plastic or rubber button boot 178 and a rigid button plunger 180, a LED frame/reflector 182, a control button board 186, LED(s) and LED board 190, a tactile switch 198, a main circuit board 202, screws 206, a battery holder 210, batteries 214, and screws 218, that along with clip-on nut(s) 219 (FIG. 3) and screws 206 fasten the lighting assembly 170 together, within, and to the lower side 132 of the bottom housing 120. The control button board 186, the LED board 190, and the main circuit board 202 include one or more circuits configured so that pushing the button 176 once/first time powers the LED(s) and LED board 190 to “ON” function, pushing the button 176 twice/second time causes the LED(s) and LED board 190 to go into repeat “FLASH” mode/function, and pushing the button 176 three times/third time powers the LED(s) and LED board 190 to “OFF” condition/function.

The swivel coupling 138 includes circular neck 200 and flange 204 extending from an upper end 208 of the bottom housing 120, a hole 212 in a bottom end 216 of the top housing 110, and a circular flange receiving compartment 220 in the top housing 110 for receiving the circular flange 204 with the hole 212 receiving the circular neck 200 to allow 360 degree rotation clockwise or counter clockwise of the bottom housing 120 relative to the top housing 110. The circular neck 200 and flange 204 include a bore 221 there through to slidably receive a locking plunger 222 of the lock/unlock device 154.

The circular flange receiving compartment 220 in the top housing 110 also receives a plunger engaging section 224 of the main lock/unlock device 154.

The top housing 110 includes a spring receiving compartment 228 that receives spring 232 and a latch receiving compartment 236 that receives latch 240.

A pair of co-axial, over lapping independent spool assemblies 250, 254 carry the independent leashes 160, 164 in the bottom housing 120 and rotate about first and second co-axial axes A1, A2. The spool assemblies 250, 254 each include spools 260, springs 264, and spool plates 268. In alternative embodiments, other numbers (e.g., 3, 4) of spool assemblies may be provided in the pet walking device 100.

The pet walking device 100 for walking two or more pets will now be described in use. A user attaches ends 280, 284 (e.g., standard, swiveling snap-shackle) of the independent leashes 160, 164 (e.g., thin, nylon cord or the like that exit the pet walking device 100 near opposite sides 134, 136 of the lower side 132) to the respective collars of the pets. Each pet may walk/run at different speeds and/or go off in different directions. Because the pair of co-axial over lapping spool assemblies 250, 254 are independently operated, spool assembly 250 may allow the leash 160 to run out and/or in from the over lapping spool assembly 250 a different amount and/or rate compared to spool assembly 254. The swivel coupling 138 allows the top housing 110 and the bottom housing 120 to swivel 360 degrees clockwise and counter clockwise relative to each other. The combination of the independent leashes 160, 164 and co-axial over lapping spool assemblies 250, 254 and the swivel coupling 138 allows the pets more freedom of motion, prevents tangles with the leashes 160, 164 and pets, and makes it easier for the walker to walk the pets.

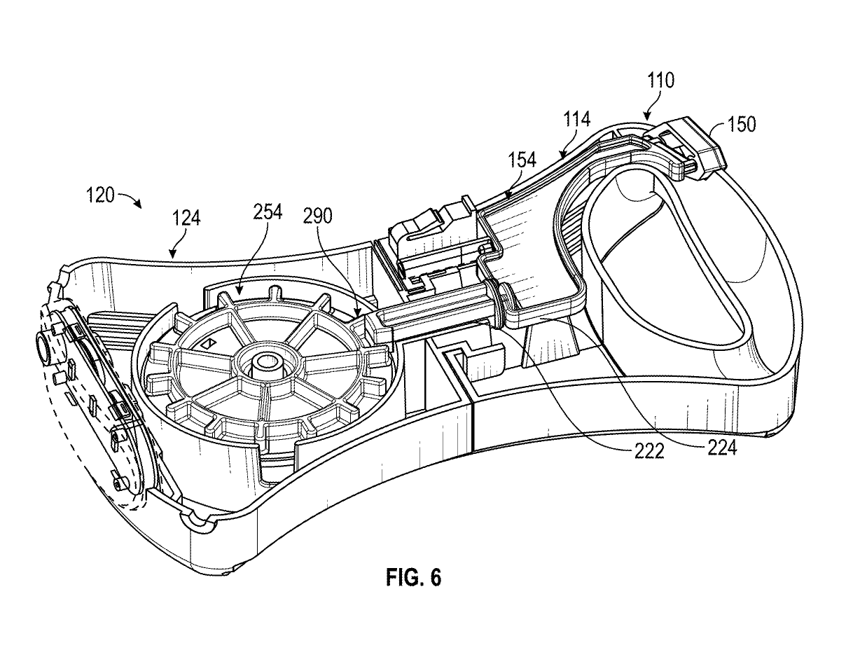

With the main lock/unlock device 154 unengaged/unlocked, the locking plunger 222 is clear from engagement section(s) 290 (FIG. 6) of the co-axial over lapping spool assemblies 250, 254, allowing the co-axial over lapping spool assemblies 250, 254 to freely rotate, enabling the leashes 160, 164 to run out from and/or onto (uncoil off and/or coil onto) the spring-loaded co-axial over lapping spool assemblies 250, 254 independently or in unison. The spool assemblies 250, 254 always operate independently of each other until the user pushes the main lock/unlock button 150 to lock mode and later pushes the main lock/unlock button 150 to release mode, only then the leashes 160, 164 will lock and release in unison.

With the main lock/unlock device 154 engaged/locked, the locking plunger 222 engages the engagement section(s) 290 of the co-axial over lapping spool assemblies 250, 254, causing the co-axial over lapping spool assemblies 250, 254 to simultaneously lock in place so that the leashes 160, 164 cannot run out from and/or onto (uncoil off and/or coil onto) the spring-loaded co-axial over lapping spool assemblies 250, 254.

The co-axial over lapping spool assemblies 250, 254 are locked in unison by pressing on the main lock/unlock button 150. This imparts movement of the main lock/unlock device 154 in the top housing 110 towards the bottom housing 120. This movement causes a lower portion of the main lock/unlock device 154 to engage the latch 240 and the spring 232. The latch 240 retains the lower portion of the main lock/unlock device 154 into a locked position/configuration while the spring 232 urges the main lock/unlock device 154 towards the handle 140. The plunger engaging section 224 urges the locking plunger 222 towards the co-axial over lapping spool assemblies 250, 254. The plunger engaging section 224 engages the engagement section(s) 290 of the co-axial over lapping spool assemblies 250, 254, causing the co-axial over lapping spool assemblies 250, 254 to simultaneously lock in place so that the leashes 160, 164 cannot run out from and/or onto (uncoil off and/or coil onto) the spring-loaded co-axial over lapping spool assemblies 250, 254.

With the main lock/unlock device 154 engaged/locked, the swivel coupling 138 still allows the top housing 110 and the bottom housing 120 to swivel 360 degrees clockwise and counter clockwise relative to each other.

To again allow the leashes 160, 164 to run out from and/or onto (uncoil off and/or coil onto) the spring-loaded co-axial over lapping spool assemblies 250, 254, the main lock/unlock device 154 is unengaged/unlocked by pressing again on the main lock/unlock button 150. This causes the latch 240 to unlock the lower portion of the main lock/unlock device 154, allowing the spring 232 to urge the main lock/unlock device 154 towards the handle 140 pulling the locking plunger out of engagement with the engagement section(s) 290 of the co-axial over lapping spool assemblies 250, 254. This enables the co-axial over lapping spool assemblies 250, 254 to freely operate, allowing the leashes 160, 164 to freely and independently run out from and/or onto (uncoil off and/or coil onto) the spring-loaded co-axial over lapping spool assemblies 250, 254.

To operate the lighting assembly 170, the button 176 is pressed once/a first time to put the lighting assembly 170 in a constant “ON” condition/function, pressed twice/a second time to put the lighting assembly 170 in a “FLASH” mode/function, and pressed three times/a third time to put the lighting assembly 170 in an “OFF” condition/function. The orientation of the lighting assembly 170 on a bottom of the bottom housing 120 causes light to shine toward the ground, illuminating the area for the walker and pets at night.

The pet walking device 100 is a unique and well-designed handheld retractable leash for walking two or more dogs, presenting dog-owners and walkers with an extraordinarily useful device, one unlike any currently on the market. First, unlike the many retractable dog leashes currently on the market, the pet walking device 100 accommodates two or more dogs on the same handheld unit and with its unique, two-part, 360-degree swiveling design, pet walking device 100 prevents the animals' leashes from becoming twisted and tangled together. Offering all the benefits that dog-owners expect from retractable leashes, the pet walking device 100 not only accommodates two dogs, but also provide a built-in lighting assembly 170 for walking at night, in fog, or other low-visibility conditions. This lighting assembly 170 is set to provide constant illumination, or to provide a light which flashes at regular intervals which is highly useful along roads, streets, and sidewalks, as a beacon to alert motorists and bicyclists to one's presence. Made with a comfortable, ergonomically shaped handle to ease hand and wrist strain, the pet walking device 100 is easy to handle, easy to control, and a pleasure to use.

The above figures may depict exemplary configurations for the invention, which is done to aid in understanding the features and functionality that can be included in the invention. The invention is not restricted to the illustrated architectures or configurations, but can be implemented using a variety of alternative architectures and configurations. Additionally, although the invention is described above in terms of various exemplary embodiments and implementations, it should be understood that the various features and functionality described in one or more of the individual embodiments with which they are described, but instead can be applied, alone or in some combination, to one or more of the other embodiments of the invention, whether or not such embodiments are described and whether or not such features are presented as being a part of a described embodiment. Thus the breadth and scope of the present invention, especially in the following claims, should not be limited by any of the above-described exemplary embodiments.

Terms and phrases used in this document, and variations thereof, unless otherwise expressly stated, should be construed as open ended as opposed to limiting. As examples of the foregoing: the term “including” should be read as mean “including, without limitation” or the like; the term “example” is used to provide exemplary instances of the item in discussion, not an exhaustive or limiting list thereof; and adjectives such as “conventional,” “traditional,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although item, elements or components of the disclosure may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

I claim:

1. A pet walking device for walking a plurality of pets, comprising:
a top housing with a handle and a bottom housing;
a swivel coupling rotatably coupling the bottom housing to the top housing for 360 degree rotation;
a plurality of co-axial overlapping spool assemblies independently rotatably disposed within the bottom housing;
a leash carried by each of the plurality of co-axial overlapping spool assemblies.

2. The pet walking device of claim 1, wherein the top housing includes a lock and unlock device operably associated with the plurality of co-axial overlapping spool assemblies to lock and unlock rotation of the plurality of co-axial overlapping spool assemblies.

3. The pet walking device of claim 1, wherein the plurality of co-axial overlapping spool assemblies include a plurality of engagement sections that the lock and unlock device engages and disengages to simultaneously lock and unlock rotation of the plurality of co-axial overlapping spool assemblies.

4. The pet walking device of claim 1, wherein the lock and unlock device is movably disposed within the swivel coupling.

5. The pet walking device of claim 4, wherein the lock and unlock device includes a plunger movably disposed within the swivel coupling.

6. The pet walking device of claim 5, wherein the plurality of co-axial overlapping spool assemblies include a plurality of engagement sections that the plunger engages and disengages to simultaneously lock and unlock rotation of the plurality of co-axial overlapping spool assemblies.

7. The pet walking device of claim 1, wherein the plurality of co-axial overlapping spool assemblies include respective springs.

8. The pet walking device of claim 1, wherein the handle includes a grip.

9. The pet walking device of claim 1, wherein the bottom housing includes a lighting assembly.

10. The pet walking device of claim 1, wherein the lighting assembly includes one or more circuits to put the lighting assembly in a constant on condition, a flash condition, and an off condition.

11. A method of using the pet walking device of claim 1, comprising:
rotating the bottom housing with respect to the top housing;
independently rotating the plurality of co-axial overlapping spool assemblies relative to each other within the bottom housing for each leash.

12. The method of claim 11, wherein the plurality of co-axial overlapping spool assemblies include a plurality of engagement sections that the lock and unlock device engages and disengages to simultaneously lock and unlock rotation of the plurality of co-axial overlapping spool assemblies, and the method further comprising:
engaging and disengaging the plurality of engagement sections of the co-axial overlapping spool assemblies with the lock and unlock device to simultaneously lock and unlock rotation of the plurality of co-axial overlapping spool assemblies.

13. The pet walking device of claim 12, wherein the lock and unlock device is movably disposed within the swivel coupling to engage and disengage the plurality of engagement sections of the co-axial overlapping spool assemblies.

14. The pet walking device of claim 11, wherein the lighting assembly includes one or more circuits to put the lighting assembly in a constant on condition, a flash condition, and an off condition, and the method further comprising causing the one or more circuits to put the lighting assembly in a constant on condition, a flash condition, and an off condition.
